(19) United States
(12) Patent Application Publication
(10) Pub. No.: US 2025/0247792 A1
(43) Pub. Date: Jul. 31, 2025

(54) POWER CONTROL FOR INTEGRATED SENSING AND COMMUNICATION

(71) Applicant: Samsung Electronics Co., Ltd., Suwon-si (KR)

(72) Inventors: Liang Hu, San Diego, CA (US); Philippe Jean Marc Michel Sartori, Naperville, IL (US)

(21) Appl. No.: 19/036,802

(22) Filed: Jan. 24, 2025

Related U.S. Application Data
(60) Provisional application No. 63/624,832, filed on Jan. 25, 2024.

(51) Int. Cl. H04W 52/02; H04L 5/00; H04W 52/24

(52) U.S. Cl. CPC H04W 52/0235; H04L 5/0048; H04W 52/248

(57) ABSTRACT

A method of performing integrated sensing and communications includes sending, by a gNB in a cellular network, a control signal and a reference signal to a user equipment; receiving, by the gNB, a first sensing signal from the user equipment, the first sensing signal having an initial power; sending, by the gNB, a power control message, to the user equipment, the power control message including a power adjustment command; receiving, by the gNB, a second sensing signal from the user equipment, the second sensing signal having a transmit power varying according to the power adjustment command; and identifying, by the gNB, an object based on the second sensing signal.

### CROSS-REFERENCE TO RELATED APPLICATION(S)

The present application claims priority to and the benefit of U.S. Provisional Application No. 63/624,832, filed Jan. 25, 2024, the entire content of which is incorporated herein by reference.

### BACKGROUND

### 1. Field

The present application relates to integrated sensing and communication between a base station and user equipment.

### 2. Description of the Related Art

As wireless technologies (e.g., largescale multiple-input multiple-output (MIMO) systems) evolve with more antenna elements and wider bandwidth in higher frequency bands (e.g., mm-wave bands), they become reliant on increasingly specific and accurate assistance information, such as distance (range), angle, instantaneous velocity, and area of objects. Additionally, wireless sensing technologies aim at acquiring information about a remote object without physical contact. The sensing data of the object and its surrounding can then be utilized for analysis so that meaningful information about the object and its characteristics can be obtained with high resolution and reliable accuracy. However, current 5G-Advanced network design focuses on data transmission and it does not offer the in-built capability to detect objects that are not connected to the network.

The present disclosure relates to systems and methods of performing integrated sensing and communications (ISAC) between a gNodeB (gNB) and a user equipment of a cellular network to detect (track) an object. The systems and methods according to embodiments of the present disclosure utilize either a base station-based (gNB-based) power control scheme or a UE-based power control scheme to adjust the power of the sensing signal transmitted by the UE, which is configured to ensure that the sensing signal generated by the UE has a high enough power such that a sensing receiver can detect the object, but not so high that the sensing signal generates interference with the data transmission of other UEs connected to the gNB of the cellular network.

The above-described information disclosed in this section is only for improving the understanding of the background of the present disclosure and thus it may include information that does not constitute prior art.

### SUMMARY

The present disclosure relates to various aspects and embodiments of a method of performing integrated sensing and communications. In one embodiment, the method includes sending, by a gNB in a cellular network, a control signal and a reference signal to a user equipment; receiving, by the gNB, a first sensing signal from the user equipment, the first sensing signal having an initial power; sending, by the gNB, a power control message, to the user equipment, the power control message including a power adjustment command; receiving, by the gNB, a second sensing signal from the user equipment, the second sensing signal having a transmit power varying according to the power adjustment command; and identifying, by the gNB, an object based on the second sensing signal.

The power control message may include an open-loop power adjustment command.

The power control message may include a closed-loop power adjustment command.

The power adjustment command may include a power ramping command.

The power ramping command may include a fixed power ramping procedure, a linear power ramping procedure, a geometric power ramping procedure, or any combination thereof.

The power control message may be configured to cause the user equipment to select a power ramping procedure from among two or more power ramping procedures stored on the user equipment.

The method may include sending, by the gNB, a second power control message to the user equipment to stop power adjusting in response to the gNB identifying the object with a threshold certainty.

The method may include receiving, by the gNB, a third sensing signal from the user equipment.

The power control message may include a radio resource control (RRC) message, a medium access control-control element (MAC-CE) message, a downlink control information (DCI) message, a synchronization signal block (SSB) message, or any combination thereof.

The power control message may specify a duration of a sensing operation by the user equipment.

The power control message may specify a quantity of sensing operations by the user equipment.

In another embodiment, the method of performing integrated sensing and communications includes receiving, by a user equipment, a control signal and a reference signal from a gNB in a cellular network; determining, by the user equipment, an initial power for sensing signal transmission based on the control signal, the reference signal, and a channel estimation; sending, by the user equipment to the gNB, a first sensing signal for object detection, the first sensing signal having the initial power; receiving, by the user equipment, a power control message from the gNB, the power control message including a power adjustment command; sending, by the user equipment to the gNB, a second sensing signal for object detection, the second sensing signal having a transmit power varying according to the power adjustment command; and receiving, by the user equipment, a power control message from the gNB to stop power adjustment in response to the gNB identifying an object.

The power control message may include an open-loop power adjustment command.

The power control message may include a closed-loop power adjustment command.

The power adjustment command may include a power ramping command.

The power ramping command may include a fixed power ramping procedure, a linear power ramping procedure, a geometric power ramping procedure, or any combination thereof.

The power control message may be configured to cause the user equipment to select a power ramping procedure from among two or more power ramping procedures stored on the user equipment.

The method may include receiving, by the user equipment, a second power control message from the gNB to stop power adjusting in response to the gNB identifying the object with a threshold certainty.

The method may include transmitting, by the user equipment, a third sensing signal to the gNB.

The power control message may include a radio resource control (RRC) message, a medium access control-control element (MAC-CE) message, a downlink control information (DCI) message, a synchronization signal block (SSB) message, or any combination thereof.

The power control message may specify a duration of a sensing operation by the user equipment.

The power control message may specify a quantity of sensing operations by the user equipment.

The present disclosure also relates to various embodiments of a user equipment. In one embodiment, the user equipment includes a processor and a non-volatile memory device connected to the processor. The non-volatile memory device includes computer readable instructions which, when executed by the processor, cause the user equipment to perform integrated sensing and communications including: receive a first control signal and a sensing reference signal from a gNB; transmit a first sensing signal to the gNB, the first sensing signal having an initial power based on at least a power of the sensing reference signal; receive a first power control message from the gNB, the first power control message comprising a power adjustment command; and transmit a second sensing signal to the gNB, the second sensing signal having a transmit power varying according to the power adjustment command. The first power control message comprises a closed-loop power adjustment command and/or a power ramping command, and the sensing reference signal is different than a reference signal for communications between the gNB and the user equipment.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable system or method of integrated sensing and communication.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1A is a schematic diagram depicting different modes of sensing an object utilizing an integrated sensing and communication (ISAC) system according to various embodiments of the present disclosure;

FIG. 1B is a schematic diagram depicting power levels of communication signals and sensing signals utilized to detect an object (Target 1);

FIG. 2A is a schematic diagram illustrating communications between a user equipment (UE) and a gNB utilizing a base station-based power control scheme to identify an object according to one embodiment of the present disclosure;

FIG. 2B is a flowchart illustrating tasks of a method of identifying an object with a UE and a gNB utilizing a base station-based power control scheme according to one embodiment of the present disclosure;

FIG. 3A is a schematic diagram illustrating communications between a user equipment (UE) and a gNB utilizing a UE-based power control scheme to identify an object according to one embodiment of the present disclosure;

FIG. 3B is a flowchart illustrating tasks of a method of identifying an object with a UE and a gNB utilizing a UE-based power control scheme according to one embodiment of the present disclosure;

FIG. 4 is a block diagram of an electronic device in a network environment, according to some embodiments of the present disclosure; and

FIG. 5 is a block diagram of a system including a UE and a gNB in communication with each other according to one embodiment of the present disclosure.

### DETAILED DESCRIPTION

The present disclosure relates to various systems and method for identifying and/or tracking an object between a user-equipment (UE) device and a base station (e.g., a Next Generation Node B (“gNB” or “gNodeB”)) of a cellular network utilizing integrated sensing and communications (ISAC). In one or more embodiments, the object may be any object not connected to the cellular network, such as traffic (e.g., vehicle monitoring, pedestrian detection, and/or animal detection), humans (e.g., fall detection and/or gesture recognition), industry (e.g., digital twin and/or smart factory), and/or environment (e.g., weather prediction, rain fall monitoring, and/or pollution monitoring). In one or more embodiments, the systems and methods for performing ISAC of the present disclosure may be utilized to facilitate outdoor smart transportation. For instance, ISAC may be performed to offer perception of blind spots in vehicular traffic areas where the line of sight of the driver is blocked or obstructed by obstacles and/or the vehicle itself (e.g., large vehicles, such as tractor-trailers, that have large blind spots and therefore tend to incur more traffic accidents). ISAC may also be performed to enable perception of dynamic vehicular transportation information. For instance, ISAC may be performed to enable traffic road jam detection and/or traffic safety risk detection (e.g., detection of dangerous driving behaviors such as speeding, sharp turning, sudden acceleration, and/or sudden braking). In one or more embodiments, the systems and methods for performing ISAC of the present disclosure may be utilized to facilitate indoor smart functionality. For instance, ISAC may be performed to conduct contactless respiration monitoring of an individual, such as infant or an elderly person (e.g., monitoring respiration to detect various respiratory diseases or conditions). ISAC may also be performed to enable gesture recognition (e.g., detect the movement of an individual's head, hand, leg, or other body part for gesture recognition).

In one or more embodiments, the UE transmits a sensing signal that reflects and/or refracts off the object and is then received by the gNB, which determines time delays, phase shifts, and/or other parameters to determine the position of the object. In one or more embodiments, the systems and methods of the present disclosure may utilize a base station-based power control scheme or a UE-based power control scheme to ramp the power of the sensing signal transmitted by the UE. Ramping the power of the sensing signal is configured to ensure that the sensing signal generated by the UE has a high enough power such that a sensing receiver can detect an object, but not so high that the sensing signal generates interference with the data transmission of other UEs connected to the gNB of the cellular network. In one or more embodiments, the ramping power scheme may result in the sensing signal generated by the UE having the minimum power level (or substantially the minimum power level) that enables detection of an object by the sensing receiver (e.g., a UE or a gNB). In one or more embodiments, the systems and methods for performing ISAC of the present disclosure may be integrated into 5G-Advanced or 6G wireless systems.

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

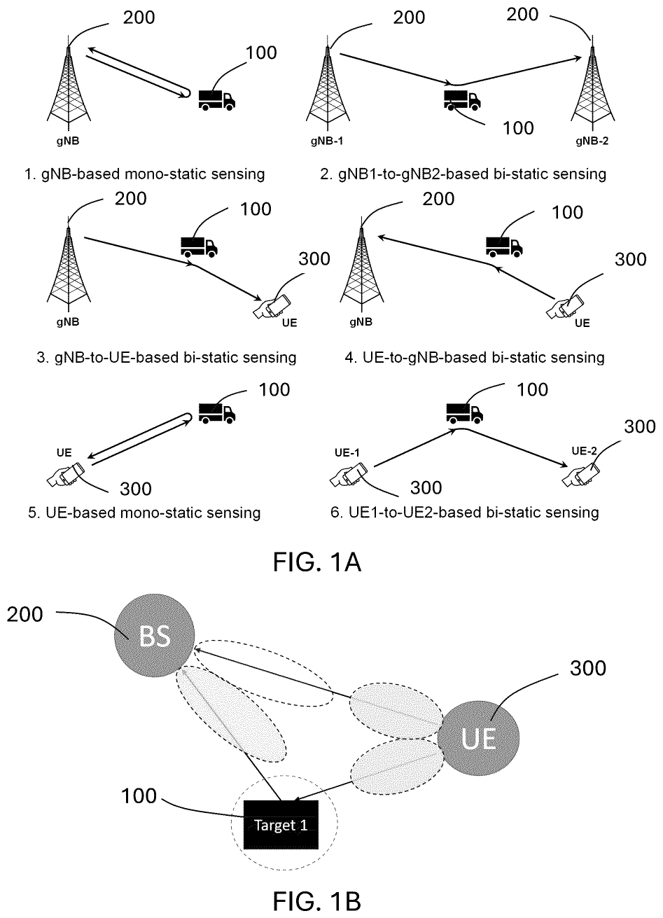

FIG. 1A depicts six (6) different modes for detecting an object 100 (e.g., a target), including (i) a mono-static sensing mode utilizing a single gNB 200; (ii) a bi-static sensing mode utilizing two gNBs 200 (labeled “gNB-1” and “gNB-2”); (iii) a bi-static sensing mode utilizing a gNB 200 and a UE 300 in which the gNB 200 generates the sensing signal and the UE 300 detects the object 100; (iv) a bi-static sensing mode utilizing a gNB 200 and a UE 300 in which the UE 300 generates the sensing signal and the gNB 200 detects the object 100; (v) a mono-static sensing mode utilizing a single UE 300; and (vi) a bi-static sensing mode utilizing two UEs 300 (labeled “UE-1” and “UE-2”). In one or more embodiments, two or more of these sensing modes may be combined to form an additional sensing mode.

FIG. 1B is a schematic diagram depicting the power levels of communication signals and sensing signals utilized by a base station (labeled “BS”) (e.g., a gNB 200) and user equipment 300 (UE) to detect an object 100 (labeled “Target 1”). As illustrated in FIG. 11B, a specific transmission power may be adequate to establish a communication link between the gNB 200 and the UE 300, but the same power level may not be sufficient for sensing signals because the sensing signals bounce off the object (target) 100. That is, the sensing signal is received a lower power than the communication signal due to the reflection off of the object (target) 100, and thus the power level utilized for communication between the gNB 200 and the UE 300 may not be sufficient for target sensing. Applying power control methods can introduce additional challenges in RF sensing processes compared to other power control interactions between UEs and gNBs for data communications, particularly in the case of bi-static sensing where the UE sends the sending signal and the gNB receives the signal. For instance, transmitting multiple occurrences of sensing signals on different beams than the communication beam (e.g., through communication link or along a trajectory bouncing off object) can involve an extra level of complexity not found in other scenarios. For instance, the extended travel distance of signals rebounding off the object (target) 100 means that a specific transmission power might be adequate for sensing signals sent via communication link, while the same power level might not suffice for sensing signals intended to bounce off or bend around object (target) 100, as shown in FIG. 1B. Embodiments of the present disclosure relate to power control methods that may be utilized depending on the various forms of the sensing signal sent along different routes.

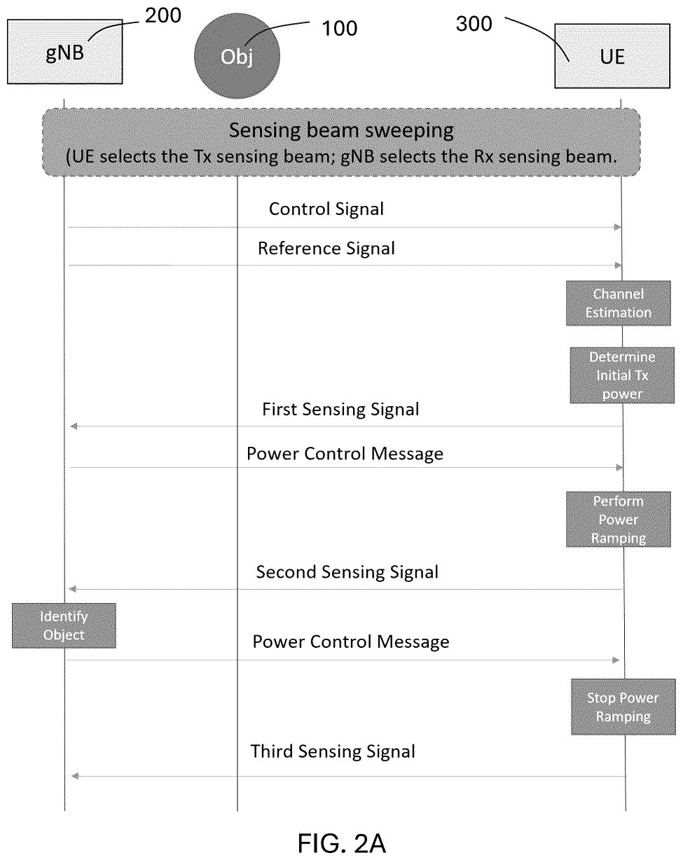

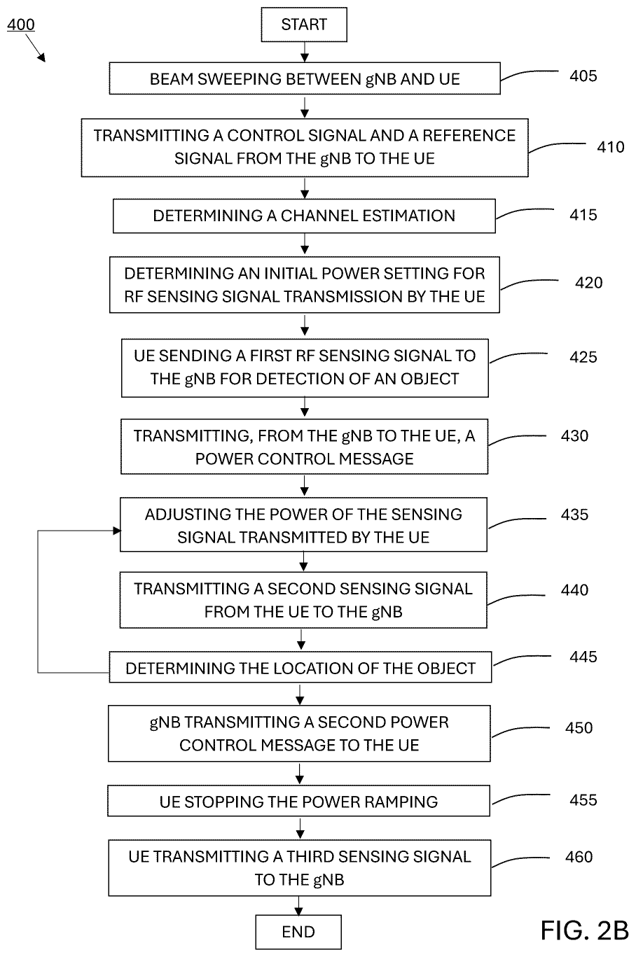

FIGS. 2A-2B depict a system and method 400 of performing bi-static sensing of an object 100 utilizing a gNB 200 and a UE 300 and with a base station-based power control scheme according to one embodiment of the present disclosure. In the illustrated embodiment, the method 400 includes a task 405 of performing beam sweeping (i.e., beam alignment) between the UE 300 and the gNB 200 for radio frequency (RF) sensing of an object between the UE 300 and the gNB 200. In task 405, the UE 300 determines one or more transmission (Tx) beam directions for RF sensing and the gNB 200 determines one or more receiving (Rx) beam directions for RF sensing. In one or more embodiments, the task 405 may include determining a set of sensing Tx/Rx beam directions between the UE 300 and the gNB 200. The beam sweeping task 405 is configured to detect all potential objects between the gNB 200 and UE 300 and then to select a sub-set of detected objects to perform tracking of the sub-set of detected objects. The beam sweeping task 405 is described in U.S. patent application Ser. No. 18/363,729, the entire contents of which are incorporated herein by reference.

In the illustrated embodiment, the method 400 also includes a task 410 of transmitting a control signal and a reference signal (i.e., a sensing reference signal) from the gNB 200 to the UE 300 (i.e., the task 410 includes receiving, by the UE 300, a control signal and a reference signal transmitted from the gNB 200). In one or more embodiments, the reference signal may include a channel start information reference signal (CSI-RS). The reference signal is a signal that may be utilized by the UE 300 to measure the radio channel quality for the purpose of sensing the environment or objects in the environment (e.g., the UE 300 may utilize the sensing reference signal to estimate channel parameters, such as channel strength and delay spread).

In the illustrated embodiment, the method 400 also includes a task 415 of the UE 300 utilizing the reference signal (received in task 410) to determine a channel estimation between the UE 300 and the gNB 200. In one or more embodiments, in task 415, the UE 300 may perform a channel estimate of a channel between the UE 300 and the gNB 200 by performing one or more measurements (e.g., received signal strength indicator (RSSI), reference signal received power (RSRP), reference signal received quality (RSRQ), signal-to-noise ratio (SNR), signal-to-interference-plus-noise ratio (SINR), and/or channel quality indicator (CQ)) on the reference signal received from the gNB 200 in task 410. In one or more embodiments, the control signal received by the UE 300 in task 410 may include information about a path loss model for RF sensing, and the task 415 of determining the channel estimation may be based on reference signal and the path loss model. In one or more embodiments, in task 415, the UE 300 may estimate the path loss between the UE 300 and the gNB 200 utilizing one or more measurements (e.g., RSSI) on the reference signal and considering reciprocal channel characteristics for communication to and from the gNB 200.

In the illustrated embodiment, the method 400 also includes a task 420 of the UE 300 determining an initial power setting for RF sensing signal transmission by the UE 300 (i.e., the initial power of the sensing signal transmitted by the UE 300 to detect and/or track the object 100). In one or more embodiments, the task 420 of determining the initial power setting may be based on the control signal(s) received from the gNB 200 in task 410, the reference signal received from the gNB 200 in task 410, the channel estimation determined in task 415, or a combination of these factors. In one or more embodiments, the power (Tx Power) of the first RF sensing signal transmitted by the UE 300 in task 420 may be set according to Equation 1 as follows:

$$Tx Power = Target Rx Power set by gNB + PathLoss factor \qquad ( Equation 1 )$$

where Tx Power is the channel power of an uplink physical channel to be transmitted (e.g., physical uplink shared channel (PUSCH), physical random access channel (PRACH), etc.), Target Rx Power set by gNB is the power that the gNB requires to safely decode the received signal (e.g., preambleReceivedTargetPower for PRACH or p0-norminalWithoutGrant for PUSCH), and PathLoss factor is the factor due to the pathloss between the UE and the gNB (e.g., the difference between the reference signal power (broadcast by the system information block (SIB)) and the measured power for the reference signal by the UE side).

In one or more embodiments, the initial power setting determined in task 420 may be set using open-loop power control methods in which the UE 300 lacks feedback from the gNB 200 to adjust the sensing signal power. In one or more embodiments, using open-loop methods, the UE 300 selects an initial power based on signal measurements, a predetermined coverage target (e.g., the object's range), and available power resources. For example, control signals from the gNB 200 may specify transmit power levels and other parameters (e.g., bandwidth or sensing intervals) for RF sensing and the UE 300 may determine the initial power based, at least in part, on these specifications. In one or more embodiments, the UE 300 may set the initial power for RF sensing in task 420 based on the channel estimation determined in task 415, with the power level being based on a desired detection range and estimated path loss to the gNB 200.

In the illustrated embodiment, the method 400 includes a task 425 of the UE 300 sending a first RF sensing signal to the gNB for detection of an object between the UE 300 and the gNB 200. In one or more embodiments, in task 425, the UE 300 may send the first sensing signal directly to gNB 200 via one pre-determined beam direction and via another pre-determined beam direction that reflects and/or refracts off the object 100 and reaches the gNB 200. Accordingly, the gNB 200 receives direct and reflected/refracted signals from the UE 300, which enables the gNB 200 to determine time delays, phase shifts, and other parameters to determine the position of the object 100. In one or more embodiments, in task 425, the first RF sensing signal sent by the UE 300 to the gNB 200 has the initial power setting determined in task 420. In one or more embodiments, the power of the first RF sensing signal sent by the UE 300 in task 425 may be based on the control signal(s) received from the gNB 200 in task 410, the reference signal received from the gNB 300 in task 410, and the channel estimation determined in task 415. For instance, in one or more embodiments, in task 425, the UE 300 may transmit the first sensing signal having one or more parameters indicated in the control signal(s) received by the UE 300 in task 410, such as RF sensing bandwidth, timing for signal transmission, repetition intervals, maximum power levels, target object range and location, or any combination of thereof. Additionally, in an embodiment in which the control signal(s) received by the UE 300 in task 410 indicate specific sensing times, the UE 300 may transmit the first sensing signal during an allotted or specified sensing period scheduled by the gNB 200.

In the illustrated embodiment, the method 400 also includes a task 430 of transmitting, from the gNB 200 to the UE 300, a power control message (i.e., a power adjustment command) regarding the RF sensing signals transmitted by the UE 300 (i.e., the task 430 includes receiving, by the UE 300, a power control message (a power adjustment command) from the gNB 200). The terms “power control message” and “power adjustment command” are used interchangeably throughout the present disclosure and they refer to a signal, transmitted by the gNB 200, that is configured to cause the UE 300 to vary (e.g., increase or decrease) the power of a sensing signal transmitted by the UE 300. In one or more embodiments, the power control message (power adjustment command) of task 430 may explicitly indicate a transmit power which is to be used by the UE 300. For example, in one or more embodiments, the power control message may indicate a second transmit power which is to be used by the UE 300 to transmit a second sensing signal (and subsequent sensing signals, if applicable) of the RF sensing procedure, described below. In the illustrated embodiment, the power control message of task 430 may indicate a power ramping procedure (e.g., power ramping scheme) which is to be performed by the UE 300 during the RF sensing procedure. That is, the power control message may specify an incremental or gradual increase and/or decrease in the power of the RF sensing signal transmitted by the UE 300. Accordingly, the power control message may be configured to cause the transmit power of the RF sensing signal transmitted by the UE 300 to be adjusted (e.g., increased or decreased) from a first transmit power to a second transmit power different than the first transmit power.

In one or more embodiments, the power control message of task 430 may be a transmission power control (TPC) message. In one or more embodiments, the power control message of task 430 may include a radio resource control (RRC) message, a medium access control-control element (MAC-CE) message, a downlink control information (DCI) message, a synchronization signal block (SSB) message, or any combination thereof. In one or more embodiments, the power control message of task 430 may specify one or more parameters of the sensing signal transmitted by the UE 300, such as, for example, a bandwidth for the sensing signals, timing for transmitting the sensing signals, pulse repetition intervals for the sensing signals, a duration of the RF sensing process, a maximum transmit power for the sensing signals, a target range for the objects, one or more locations of the objects, or any combination thereof. For instance, in one or more embodiments, the power control message of task 430 may be a RRC message containing (i) a power increment or step between sensing signals transmitted by the UE 300; (ii) a time difference or delay between the sensing signals having the different power levels; and/or (iii) the resources where to transmit the sensing signal.

In one or more embodiments, the UE 300 may store a set of power ramping procedures or be configured (e.g., pre-configured or configured via RRC signaling) with a set of power ramping procedures, and the power control message from the gNB 200 in task 430 may indicate (e.g., via one or more-bit field values) which power ramping procedure of the set of power ramping procedures is to be performed by the UE 300. In one or more embodiments, the set of power ramping procedures may include two or more different types or kinds of power ramping procedures, such as, for example, a fixed power ramping procedure, a linear power ramping procedure, and a geometric power ramping procedure. For example, in an embodiment in which the power control message of task 430 instructs the UE 300 to perform a fixed ramping procedure, the UE 200 may adjust (e.g., increase) the transmit power of the RF sensing procedure by a fixed amount (i.e., a fixed unit). In an embodiment in which power control message of task 430 instructs the UE 300 to perform a linear ramping procedure, the UE 300 may adjust (e.g., increase) the transmit power of the RF sensing signal transmitted by the UE 300 by a linear step. In one or more embodiments, the power control message from the gNB 200 in task 430 may cause the power of the sensing signal transmitted from the UE 300 to vary (e.g., increase) according to the fixed power ramping scheme of Equation 2 as follows:

$$P\_tx ( i ) = ( i + 1 ) xP\_tx ( 0 ) \qquad ( Equation 2 )$$

where P_tx(0) is the initial transmission power of the sensing signal transmitted from the UE 300 and i is the transmission power of i-th sensing signal transmitted from the UE 300. In one or more embodiments, the power control message from the gNB 200 in task 430 may cause the power of the sensing signal transmitted from the UE 300 to vary (e.g., increase) according to the linear step ramping scheme of Equation 3 as follows:

$$P\_tx ( i ) = \frac{{i}^{2} + i + 1}{2} * P\_tx ( 0 ) \qquad ( Equation 3 )$$

where P_tx(0) is the initial transmission power of the sensing signal transmitted from the UE 300 and i is the transmission power of i-th sensing signal transmitted from the UE 300. According to Equation 3, the power of sensing signal transmitted from the UE 300 may increase according to integer multiples of the initial transmission power (e.g., P_tx(0), 2*P_tx(0), 3*P_tx(0)). In one or more embodiments, the power ramping scheme may be any suitable combination of a fixed ramping scheme, a linear ramping scheme, and a geometric ramping scheme.

In one or more embodiments, the power control scheme indicated by the power control message transmitted by the gNB 200 in task 430 may be implemented per object (i.e., per target), per-beam, or both. For example, in one or more embodiments, the power control message may instruct the UE 300 to focus subsequent sensing signals toward a determined or estimated position of the object 100. In one or more embodiments, the power control message may indicate one or more beams of the sensing signal (transmitted by the UE 300) to which the power control message applies. For example, in an embodiment in which the RF sensing procedure is performed via beam sweeping at the UE 300, the power control message may specify the beams to which the power control command applies. In one or more embodiments, the power control command may instruct the UE 300 to adjust (e.g., increase) a transmit power for specific beams, perform a power ramping procedure for specific beams, or both.

In the illustrated embodiment, the method 400 also includes a task 435 adjusting (e.g., increasing or decreasing) the power of the sensing signal transmitted by the UE 300 according to the power ramping schedule indicated in the power control message received by the UE 300 in task 430. For instance, the task 435 may include the UE 300 progressively or gradually increasing the power of the sensing signal in a fixed power ramping manner (e.g., Equation 2 above), a linear power ramping manner (e.g., Equation 3 above), or a geometric power ramping manner.

In the illustrated embodiment, the method 400 also includes a task 440 of transmitting a second sensing signal from the UE 300 to the gNB 200, either directly or indirectly. The second sensing signal transmitted from the UE 300 in task 440 has the power determined in task 435.

In the illustrated embodiment, the method 400 also includes a task 445 of the gNB 200 determining the location (i.e., spatial position) of an object 100 (e.g., tracking an object) based on the second sensing signal transmitted from the UE 300 reflecting and/or refracting off of the object 100 and reaching the gNB 200. In one or more embodiments, in task 445, the gNB 200 may determine time delays, phase shifts, and other parameters to determine the position of the object 100. Additionally, in one or more embodiments, in task 445, the gNB 200 may determine the location of the object 100 based on the second sensing signal with sufficient detection certainty or reliability (e.g., the gNB 200 may identify the object 100 with a detection certainty metric above a threshold). Alternatively, in one or more embodiments, in task 445, the gNB 200 may identify the object 100 with a detection certainty that falls below the threshold certainty metric. In one or more embodiments, the method 400 may include repeatedly performing the task 435 of adjusting (e.g., ramping up or ramping down) the power of the sensing signal transmitted by the UE 300 in accordance with the power control message transmitted by the gNB 200 in task 430, the task 440 of transmitting the sensing signal having the set power level from the UE 300 to the gNB 200, and the task 445 of identifying the object 100 by the gNB 200 until the object identified in task 445 is identified with sufficient detection certainty or reliability. The UE 300 may be configured to selectively adjust (e.g., ramp up, ramp down) a transmit power for each sensing occasion (e.g., each sensing signal) in accordance with the indicated power ramping procedure received by the UE 300 in task 430. Accordingly, the UE 300 may perform the power ramping procedure autonomously without explicit signaling from the gNB 200 other than the initial power ramping command in task 430.

In the illustrated embodiment, the method 400 also includes a task 450 of the gNB 200 transmitting a second power control message to the UE 300 (i.e., the task 450 includes the UE 300 receiving a second power control message from the gNB 200). The second power control message may be a TPC message. In one or more embodiments, the second power control message may include a radio resource control (RRC) message, a medium access control-control element (MAC-CE) message, a downlink control information (DCI) message, a synchronization signal block (SSB) message, or any combination thereof.

The second power control message of task 450 may be based on (e.g., in response to) the second sensing signal transmitted by the UE 300 in task 440. In one or more embodiments, the second power control message may be configured to cause the UE 300 to continue to adjust the power of the sensing signal in accordance with the power ramping schedule contained in the power control message of task 430. In one or more embodiments, the second power control message may be configured to cause the UE 300 to adjust (e.g., increase or decrease) the power of the sensing signal, such as in accordance with a power ramping schedule different than the power ramping schedule specified in task 430. In one or more embodiments, the second power control message in task 450 may instruct the UE 300 to stop the power ramping indicated in task 430 (i.e., the task 450 may cause the UE 300 to stop adjusting the power level of the sensing signals transmitted by the UE 300). The task 450 may be performed in response to the power of the sensing signal transmitted from the UE 300 reaching a desired power (e.g., a minimum power sufficient to enable detection of the object by the gNB 200). In one or more embodiments, the power control message transmitted in task 450 may instruct the UE 300 to stop increasing the power or to decrease the power of the sensing signal in response to the gNB 200 determining the location of the object with a detection certainty above a threshold certainty metric in task 445.

In one or embodiments, the method 400 may not include the task 450 of the gNB 200 sending the second power control message for the UE 300 to stop adjusting the power level and the UE 300 may be configured to automatically stop adjusting the power level of the sensing signals. For instance, in one or more embodiments, the first power control message of task 430 may specify a duration (i.e., a time interval) for performing the power ramping procedure and thus the UE 300 may automatically stop adjusting the power level of the sensing signals at the expiration of the specified duration. In one or more embodiments, the first power control message of task 430 may specify a quantity of sensing operations (e.g., a number of transmissions of the sensing signal from the UE 300) for performing the power ramping procedure and thus the UE 300 may automatically stop adjusting the power level of the sensing signals after performing the specified number of sensing operations.

In the illustrated embodiment, the method 400 also includes a task 455 of the UE 300 stopping the power ramping of the power of the sensing signal transmitted by the UE 300 (i.e., ceasing to increase the power of the sensing signal specified in the power ramping schedule) in response to the UE 300 receiving the power control message in task 450.

In the illustrated embodiment, the method 400 also includes a task 460 of the UE 300 transmitting a third sensing signal to the gNB 200 for the detection of one or more objects 100. The task 460 of transmitting the third sensing signal from the UE 300 may be performed in response to the gNB 200 determining the location of the object 100 with a detection certainty above a threshold certainty metric in task 445. In one or more embodiments, the third sensing signal has a power that was reached according to the power ramping schedule when the UE 200 received the second power control message in task 450. In one or more embodiments, the third sensing signal may have a default power level. In one or more embodiments, the default power level may be specified in the control signal of task 410, the first power control message of task 430, or the second power control message of task 450. In one or more embodiments, the UE 300 may store the default power level or be configured (e.g., pre-configured or configured via signaling) with the default power level for the third sensing signal.

In the above-described manner, the UE 300 and the gNB 200 are configured to perform bi-static sensing of one or more objects between the UE 300 and the gNB 200. The above-described tasks, including sending a power ramping procedure to the UE 300 from the gNB 200 and the UE 300 gradually ramping the power of the sensing signal transmitted from the UE 300 in accordance with the power ramping schedule and without further explicit signaling from the gNB 200, are advantageous because the gNB 200 may lack sufficient information to determine the optimal power level necessary for detecting the object without interfering with data communication with other UEs.

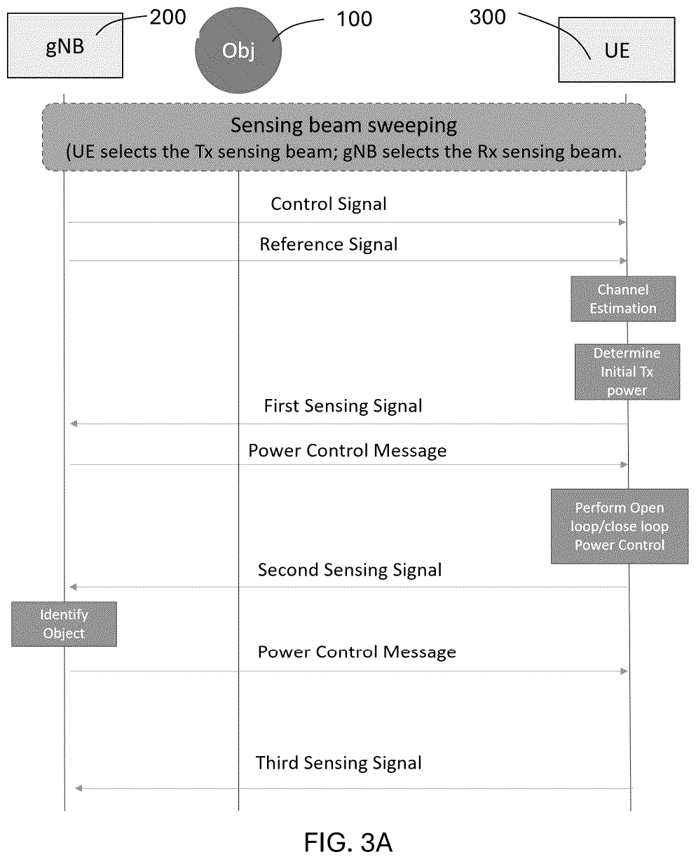

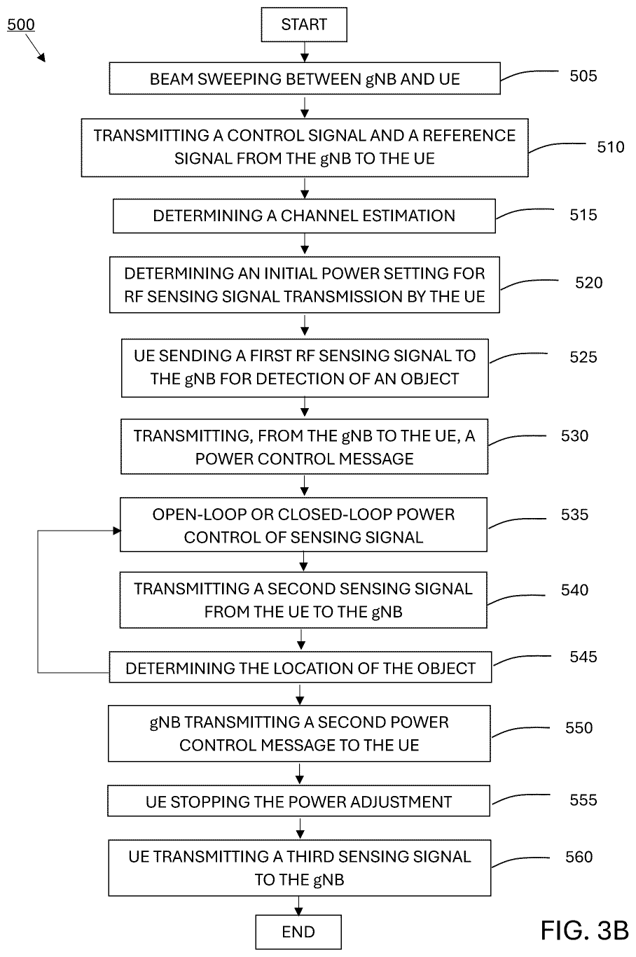

FIGS. 3A-3B depict a system and method 500 of performing bi-static sensing of an object 100 utilizing a gNB 200 and a UE 300 with a base station-based power control scheme according to one embodiment of the present disclosure. In the illustrated embodiment, the method 500 includes a task 505 of performing beam sweeping (i.e., beam alignment) between the UE 300 and the gNB 200 for radio frequency (RF) sensing of an object between the UE 300 and the gNB 200. In task 505, the UE 300 determines one or more transmission (Tx) beam directions for RF sensing and the gNB 200 determines one or more receiving (Rx) beam directions for RF sensing. In one or more embodiments, the task 505 may include determining a set of sensing Tx/Rx beam directions between the UE 300 and the gNB 200. The beam sweeping task 505 is configured to detect all potential objects between the gNB 200 and UE 300 and then to select a sub-set of detected objects to perform tracking of the sub-set of detected objects. The beam sweeping task 505 is described in U.S. patent application Ser. No. 18/363,729, the entire contents of which are incorporated herein by reference.

In the illustrated embodiment, the method 500 also includes a task 510 of transmitting a control signal and a reference signal from the gNB 200 to the UE 300 (i.e., the task 500 includes receiving, by the UE 300, a control signal and a reference signal transmitted from the gNB 200). In one or more embodiments, the reference signal may include a channel start information reference signal (CSI-RS).

In the illustrated embodiment, the method 500 also includes a task 515 of the UE 300 utilizing the reference signal (received in task 410) to determine a channel estimation between the UE 300 and the gNB 200. In one or more embodiments, in task 515, the UE 300 may perform a channel estimate of a channel between the UE 300 and the gNB 200 by performing one or more measurements (e.g., received signal strength indicator (RSSI), reference signal received power (RSRP), reference signal received quality (RSRQ), signal-to-noise ratio (SNR), signal-to-interference-plus-noise ratio (SINR), and/or channel quality indicator (CQ)) on the reference signal received from the gNB 200 in task 510. In one or more embodiments, the control signal received by the UE 300 in task 510 may include information about a path loss model for RF sensing, and the task 515 of determining the channel estimation may be based on reference signal and the path loss model. In one or more embodiments, in task 515, the UE 300 may estimate the path loss between the UE 300 and the gNB 200 utilizing one or more measurements (e.g., RSSI) on the reference signal and considering reciprocal channel characteristics for communication to and from the gNB 200.

In the illustrated embodiment, the method 500 also includes a task 520 of the UE 300 determining an initial power setting for RF sensing signal transmission by the UE 300 (i.e., the initial power of the sensing signal transmitted by the UE 300 to detect and/or track the object 100). In one or more embodiments, the task 520 of determining the initial power setting may be based on the control signal(s) received from the gNB 200 in task 510, the reference signal received from the gNB 200 in task 510, the channel estimation determined in task 515, or a combination of these factors. In one or more embodiments, the power (Tx Power) of the first RF sensing signal transmitted by the UE 300 in task 520 may be set according to Equation 1 as follows:

$$Tx Power = Target Rx Power set by gNB + PathLoss factor \qquad ( Equation 1 )$$

where Tx Power is the channel power of an uplink physical channel to be transmitted (e.g., physical uplink shared channel (PUSCH), physical random access channel (PRACH), etc.), Target Rx Power set by gNB is the power that the gNB requires to safely decode the received signal (e.g., preambleReceivedTargetPower for PRACH or p0-norminalWithoutGrant for PUSCH), and PathLoss factor is the factor due to the pathloss between the UE and the gNB (e.g., the difference between the reference signal power (broadcast by the system information block (SIB)) and the measured power for the reference signal by the UE side).

In the illustrated embodiment, the method 500 includes a task 525 of the UE 300 sending a first RF sensing signal to the gNB for detection of an object 100 between the UE 300 and the gNB 200. In one or more embodiments, in task 525, the UE 300 may send the first sensing signal directly to gNB 200 via one pre-determined beam direction and via another pre-determined beam direction that reflects and/or refracts off the object 100 and reaches the gNB 200. Accordingly, the gNB 200 receives direct and reflected/refracted signals from the UE 300, which enables the gNB 200 to determine time delays, phase shifts, and other parameters to determine the position of the object 100. In one or more embodiments, in task 525, the first RF sensing signal sent by the UE 300 to the gNB 200 has the initial power setting determined in task 520. In one or more embodiments, the power of the first RF sensing signal sent by the UE 300 in task 525 may be based on the control signal(s) received from the gNB 200 in task 510, the reference signal received from the gNB 300 in task 510, and the channel estimation determined in task 515. For instance, in one or more embodiments, in task 525, the UE 300 may transmit the first sensing signal having one or more parameters indicated in the control signal(s) received by the UE 300 in task 510, such as RF sensing bandwidth, timing for signal transmission, repetition intervals, maximum power levels, target object range and location, or any combination of thereof. Additionally, in an embodiment in which the control signal(s) received by the UE 300 in task 510 indicate specific sensing times, the UE 300 may transmit the first sensing signal during an allotted or specified sensing period scheduled by the gNB 200.

In the illustrated embodiment, the method 500 also includes a task 530 of transmitting, from the gNB 200 to the UE 300, a power control message regarding the RF sensing signals transmitted by the UE 300 (i.e., the task 530 includes receiving, by the UE 300, a power control message from the gNB 200). The power control message in task 530 may instruct the UE 300 to perform either open-loop power adjustment or closed-loop power adjustment, as described below.

In the illustrated embodiment, the method 500 also includes a task 535 of the UE 300 performing open-loop or closed-loop power control to adjust the power of the sensing signal transmitted by the UE 300 to track the object 100. In one or more embodiments, in task 535, the UE 300 may perform an open-loop power control adjustment (e.g., not based on feedback from the gNB 200). In one or more embodiments, in task 535, the UE 300 may perform a closed-loop power control adjustment (e.g., based on feedback from the gNB 200). In one or more embodiments, in task 535, the gNB 200 may be configured to cause the UE 300 to adjust the power of the sensing signal in a closed-loop manner based on a strength of the first sensing signal received at the gNB 200 in task 525, an absence or presence of objects detected based on the first sensing signal transmitted by the UE 300 in task 525, or both. For instance, in one or more embodiments, the gNB 200 may detect a weak target (e.g., a weak first sensing signal received in task 525) and may instruct the UE 300, via the power control message transmitted in task 530, to increase the transmit power of the sensing signal transmitted by the UE 300. In such cases, increasing the transmit power of the sensing signal transmitted by the UE 300 may reduce or eliminate false-positive and false-negative object detection errors. Accordingly, the gNB 200 may instruct the UE 300 to increase the transmit power of sensing signal transmitted by the UE 300 in order to reduce a detection uncertainty and increase an efficiency and/or an accuracy of the RF sensing procedure. In this manner, the task 535 of performing closed-loop power control may be used to improve the range, transmit power, and detection performance of the RF sensing procedure.

In the illustrated embodiment, the method 500 also includes a task 540 of transmitting a second sensing signal from the UE 300 to the gNB 200, either directly or indirectly. The second sensing signal transmitted from the UE 300 in task 540 has the power determined according to the open-loop or closed-loop power adjustment procedure in task 535.

In the illustrated embodiment, the method 500 also includes a task 545 of the gNB 200 determining the location (i.e., spatial position) of an object 100 (e.g., tracking an object) based on the second sensing signal transmitted from the UE 300 reflecting and/or refracting off of the object 100 and reaching the gNB 200. In one or more embodiments, in task 545, the gNB 200 may determine time delays, phase shifts, and other parameters to determine the position of the object 100. Additionally, in one or more embodiments, in task 545, the gNB 200 may determine the location of the object 100 based on the second sensing signal with sufficient detection certainty or reliability (e.g., the gNB 200 may identify the object 100 with a detection certainty metric above a threshold). Alternatively, in one or more embodiments, in task 545, the gNB 200 may identify the object 100 with a detection certainty that falls below the threshold certainty metric. In one or more embodiments, the method 500 may include repeatedly performing the task 535 of adjusting (e.g., in a closed-loop or open-loop manner) the power of the sensing signal transmitted by the UE 300 in accordance with the power control message transmitted by the gNB 200 in task 230, the task 240 of transmitting the sensing signal having the set power level from the UE 300 to the gNB 200, and the task 545 of identifying the object 100 by the gNB 200 until the object 100 identified in task 245 is identified with sufficient detection certainty or reliability. The UE 300 may be configured to selectively adjust (e.g., in a closed-loop or open-loop manner) a transmit power for each sensing occasion (e.g., each sensing signal) in accordance with the power control message received by the UE 300 in task 530.

In the illustrated embodiment, the method 500 also includes a task 550 of the gNB 200 transmitting a second power control message to the UE 300 (i.e., the task 550 includes the UE 300 receiving a second power control message from the gNB 200). The second power control message may be a TPC message. In one or more embodiments, the second power control message may include a radio resource control (RRC) message, a medium access control-control element (MAC-CE) message, a downlink control information (DCI) message, a synchronization signal block (SSB) message, or any combination thereof.

The second power control message of task 550 may be based on (e.g., in response to) the second sensing signal transmitted by the UE 300 in task 540. In one or more embodiments, the second power control message may be configured to cause the UE 300 to continue to adjust the power of the sensing signal (e.g., in a closed-loop or open-loop manner) in accordance with the power control message transmitted by the gNB 200 in task 530. In one or more embodiments, the second power control message may be configured to cause the UE 300 to adjust (e.g., increase or decrease) the power of the sensing signal in a different manner than that specified in task 530. In one or more embodiments, the second power control message in task 550 may instruct the UE 300 to stop adjusting the power of the sensing signal transmitted by the UE 300. The task 550 may be performed in response to the power of the sensing signal transmitted from the UE 300 reaching a desired power (e.g., a minimum power sufficient to enable detection of the object by the gNB 200). In one or more embodiments, the power control message transmitted in task 550 may instruct the UE 300 to stop increasing the power or to decrease the power of the sensing signal in response to the gNB 200 determining the location of the object 100 with a detection certainty above a threshold certainty metric in task 545.

In one or embodiments, the method 500 may not include the task 550 of the gNB 200 sending the second power control message for the UE 300 to stop adjusting the power level and the UE 300 may be configured to automatically stop adjusting the power level of the sensing signals. For instance, in one or more embodiments, the first power control message of task 530 may specify a duration (i.e., a time interval) for performing the power adjusting procedure and thus the UE 300 may automatically stop adjusting the power level of the sensing signals at the expiration of the specified duration. In one or more embodiments, the first power control message of task 530 may specify a quantity of sensing operations (e.g., a number of transmissions of the sensing signal from the UE 300) for performing the power adjusting procedure and thus the UE 300 may automatically stop adjusting the power level of the sensing signals after performing the specified number of sensing operations.

In the illustrated embodiment, the method 500 also includes a task 555 of the UE 300 stopping the adjustment of the power of the sensing signal transmitted by the UE 300 (i.e., ceasing to increase or decrease the power of the sensing signal in the open-loop or closed-loop manner) in response to the UE 300 receiving the second power control message in task 550.

In the illustrated embodiment, the method 500 also includes a task 560 of the UE 300 transmitting a third sensing signal to the gNB 200 for the detection of one or more objects 100. The task 560 of transmitting the third sensing signal from the UE 300 may be performed in response to the gNB 200 determining the location of the object 100 with a detection certainty above a threshold certainty metric in task 545. In one or more embodiments, the third sensing signal has a power that was reached when the UE 300 received the second power control message in task 550. In one or more embodiments, the third sensing signal may have a default power level. In one or more embodiments, the default power level may be specified in the control signal of task 510, the first power control message of task 530, or the second power control message of task 550. In one or more embodiments, the UE 300 may store the default power level or be configured (e.g., pre-configured or configured via signaling) with the default power level for the third sensing signal.

In the above-described manner, the UE 300 and the gNB 200 are configured to perform bi-static sensing of one or more objects 100 between the UE 300 and the gNB 200.

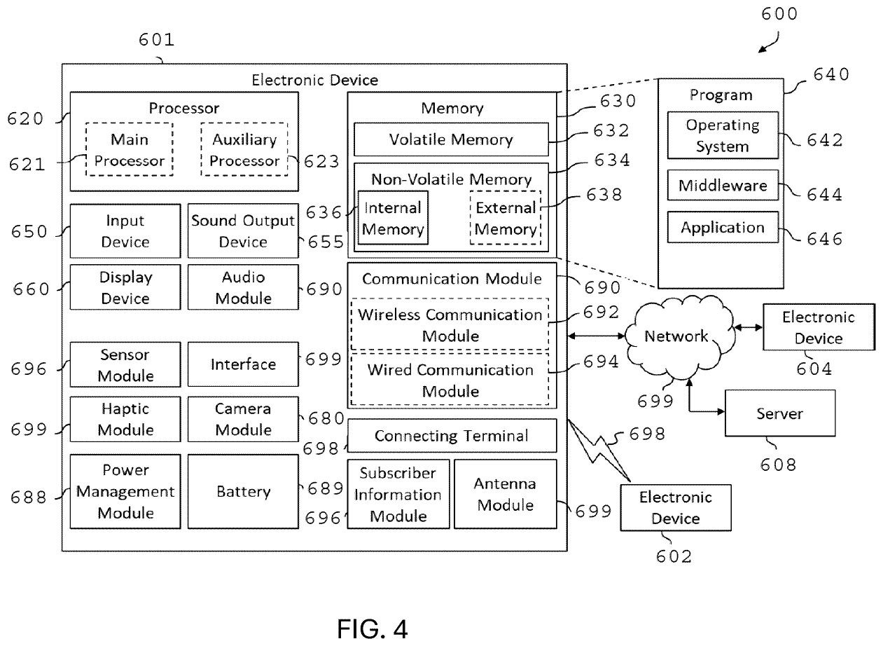

FIG. 4 is a block diagram of an electronic device in a network environment, according to some embodiments of the present disclosure. Referring to FIG. 4, an electronic device 601 in a network environment 600 may communicate with an electronic device 602 via a first network 698 (e.g., a short-range wireless communication network), or with an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, and/or an antenna module 697. In one embodiment, at least one of the components (e.g., the display device 660 or the camera module 680) may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled to the processor 620, and may perform various data processing or computations.

As at least part of the data processing or computations, the processor 620 may load a command or data received from another component (e.g., the sensor module 676 or the communication module 690) in volatile memory 632, may process the command or the data stored in the volatile memory 632, and may store resulting data in non-volatile memory 634. The processor 620 may include a main processor 621 (e.g., a central processing unit or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or to execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690), as opposed to the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 660 may visually provide information to the outside (e.g., to a user) of the electronic device 601. The display device 660 may include, for example, a display, a hologram device, or a projector, and may include control circuitry to control a corresponding one of the display, hologram device, and projector. The display device 660 may include touch circuitry adapted to detect a touch, or may include sensor circuitry (e.g., a pressure sensor) adapted to measure the intensity of force incurred by the touch.

The audio module 670 may convert a sound into an electrical signal and vice versa. The audio module 670 may obtain the sound via the input device 650 or may output the sound via the sound output device 655 or a headphone of an external electronic device 602 directly (e.g., wired) or wirelessly coupled to the electronic device 601.

The sensor module 676 may detect an operational state (e.g., power or temperature) of the electronic device 601, or an environmental state (e.g., a state of a user) external to the electronic device 601. The sensor module 676 may then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 677 may support one or more specified protocols to be used for the electronic device 601 to be coupled to the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected to the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus, which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power that is supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell that is not rechargeable, a secondary cell that is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608), and may support performing communication via the established communication channel. The communication module 690 may include one or more communication processors that are operable independently from the processor 620 (e.g., the AP), and may support a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)), or via the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas. The communication module 690 (e.g., the wireless communication module 692) may select at least one of the one or more antennas appropriate for a communication scheme used in the communication network, such as the first network 698 or the second network 699. The signal or the power may then be transmitted or received between the communication module 690 and the external electronic device via the selected at least one antenna.

Commands or data may be transmitted or received between the electronic device 601 and the external electronic device 604 via the server 608 coupled to the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, cloud computing, distributed computing, or client-server computing technology may be used, for example.

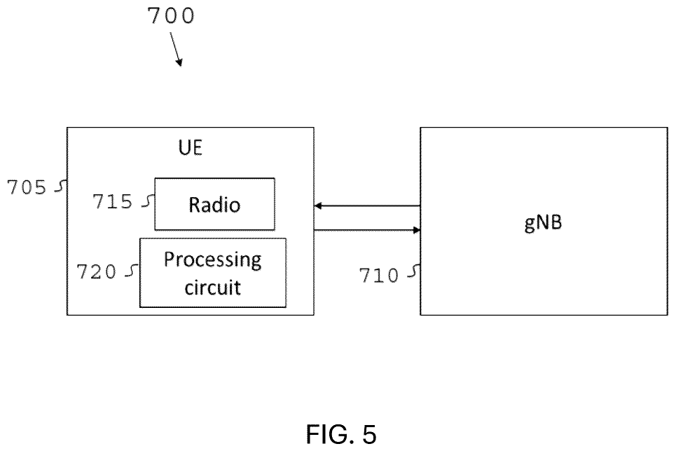

FIG. 5 shows a system 700 including a UE 705 and a gNB 710, in communication with each other. The UE may include a radio 715 and a processing circuit (or a means for processing) 720, which may perform various methods disclosed herein, e.g., the method 400 illustrated in FIG. 2B or the method 500 illustrated in FIG. 3B. For example, the processing circuit 720 may receive, via the radio 715, transmissions from the network node (gNB) 710, and the processing circuit 720 may transmit, via the radio 715, signals to the gNB 710.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of performing integrated sensing and communications, the method comprising:
receiving, by a user equipment, a first control signal and a sensing reference signal from a gNB;
transmitting, by the user equipment, a first sensing signal to the gNB, the first sensing signal having an initial power based on at least a power of the sensing reference signal;
receiving, by the user equipment, a first power control message from the gNB, the first power control message comprising a power adjustment command; and
transmitting, by the user equipment, a second sensing signal to the gNB, the second sensing signal having a transmit power varying according to the power adjustment command,
wherein the first power control message comprises a closed-loop power adjustment command and/or a power ramping command, and
wherein the sensing reference signal is different than a reference signal for communications between the gNB and the user equipment.

2. The method of claim 1, wherein the first control signal includes a path loss model between the gNB and the user equipment for sensing through control signals.

3. The method of claim 1, wherein the first control signal includes the initial power for the first sensing signal.

4. The method of claim 1, wherein the first power control message comprises information selected from the group consisting of bandwidth for sensing signals, timing for transmitting sensing signals, pulse repetition intervals, a duration for an RF sensing process, a maximum transmit power for sensing signals, a target range for objects, locations of objects, or a combination thereof.

5. The method of claim 4, further comprising selecting, by the user equipment, the initial power based on signal measurements, a predetermined coverage target, and available power resources.

6. The method of claim 4, further comprising selecting, by the user equipment, the initial power based on a channel estimation determined by the user equipment, wherein the initial power is based on a desired detection range and an estimated path loss to the gNB.

7. The method of claim 1, wherein the first power control message or a second power control message and a power control signal for communications between the gNB and the user equipment are received substantially simultaneously by the user equipment.

8. The method of claim 1, wherein the first power control message comprises the power ramping command, and wherein the power ramping command comprises a power ramping procedure selected from the group consisting of a fixed power ramping procedure, a linear power ramping procedure, a geometric power ramping procedure, and combinations thereof.

9. The method of claim 1, wherein the user equipment, in response to the first power control message, selects a power ramping procedure from among a plurality of power ramping procedures stored on the user equipment.

10. The method of claim 1, further comprising receiving, by the UE, a second power control message from the gNB to stop power adjusting in response to the gNB identifying an object with a threshold certainty.

11. The method of claim 10, further comprising transmitting, by the user equipment, a third sensing signal to the gNB.

12. The method of claim 1, wherein the first power control message comprises a message selected from the group consisting of a radio resource control (RRC) message, a medium access control-control element (MAC-CE) message, a downlink control information (DCI) message, a synchronization signal block (SSB) message, and any combination thereof.

13. The method of claim 1, wherein the first power control message specifies a duration of a sensing operation by the user equipment.

14. The method of claim 1, wherein the first power control message specifies a quantity of sensing operations by the user equipment.

15. A method of performing integrated sensing and communications, the method comprising:
receiving, by a user equipment, a control signal and a sensing reference signal from a gNB in a cellular network;
determining, by the user equipment, an initial power for sensing signal transmission based on the control signal, the reference signal, and a channel estimation;
transmitting, by the user equipment, a first sensing signal for object detection to the gNB, the first sensing signal having the initial power;
receiving, by the user equipment, a first power control message from the gNB, the first power control message comprising a power adjustment command;
transmitting, by the user equipment, a second sensing signal for object detection to the gNB, the second sensing signal having a transmit power varying according to the power adjustment command; and
receiving, by the user equipment, a second power control message from the gNB to stop power adjustment in response to the gNB identifying an object,
wherein the sensing reference signal is different than a reference signal for communications between the gNB and the user equipment.

16. The method of claim 15, wherein the first power control message comprises an open-loop power adjustment command.

17. The method of claim 15, wherein the first power control message comprises a closed-loop power adjustment command.

18. The method of claim 15, wherein the power adjustment command comprises a power ramping command.

19. The method of claim 18, wherein the power ramping command comprises a power ramping procedure selected from the group consisting of a fixed power ramping procedure, a linear power ramping procedure, a geometric power ramping procedure, and combinations thereof.

20. A user equipment comprising:
a processor; and
a non-volatile memory device connected to the processor, the non-volatile memory device comprising computer readable instructions which, when executed by the processor, cause the user equipment to perform integrated sensing and communications comprising:
receive a first control signal and a sensing reference signal from a gNB;
transmit a first sensing signal to the gNB, the first sensing signal having an initial power based on at least a power of the sensing reference signal;
receive a first power control message from the gNB, the first power control message comprising a power adjustment command; and
transmit a second sensing signal to the gNB, the second sensing signal having a transmit power varying according to the power adjustment command,
wherein the first power control message comprises a closed-loop power adjustment command and/or a power ramping command, and
wherein the sensing reference signal is different than a reference signal for communications between the gNB and the user equipment.
